(19) United States
(12) Patent Application Publication
(10) Pub. No.: US 2026/0070471 A1
(43) Pub. Date: Mar. 12, 2026

(54) METHOD, SYSTEM AND CONTROLLER FOR SEAT ADJUSTMENT

(71) Applicant: HON HAI PRECISION INDUSTRY CO., LTD., New Taipei (TW)

(72) Inventor: KUO-HUA CHEN, New Taipei (TW)

(21) Appl. No.: 18/883,161

(22) Filed: Sep. 12, 2024

(51) Int. Cl. B60N 2/02; B60N 2/06

(52) U.S. Cl. CPC B60N 2/0268; B60N 2/0272; B60N 2/067

(57) ABSTRACT

A method for adjusting a seat is provided. The method includes obtaining, through a sensor system, a first distance starting from a front surface of a seat pan of the seat to a first point sensible by the sensor system and a second distance starting from a rear surface of a seat back of the seat to a second point sensible by the sensor system; and adjusting the seat forward or backward according to the first distance and the second distance through a seat adjustment mechanism. In addition, a system and a controller employing this method are also provided.

### FIELD

The present disclosure generally relates to seat adjustment and, more particularly, to a method, system, and controller for detecting the position of a seat using sensors and automatically adjusting the seat accordingly.

### BACKGROUND

Existing seats, including cinema seats, car seats, airplane seats, and the like, typically have adjustable mechanisms. A user can manually adjust various parameters of a seat based on its physical conditions and comfort requirements, such as the height of the seat, the angle of the seat back, and the forward or backward position of the seat cushion or the seat pan. However, this adjustment method usually requires the user or someone else to manually adjust, and during the adjustment process, multiple attempts may be necessary to find the most suitable position and angle. Moreover, when multiple seats are arranged in multiple rows, the adjustment process may also affect others seated in the rows behind. Such adjustments are not only tedious and inconvenient but may also cause discomfort or injury to others due to improper adjustments.

Furthermore, due to differences in body features such as height and leg length, different individuals require different seat parameters.

Therefore, there is room for improvement in a method and a system that can instantly, comprehensively, and automatically adjust the seat, which can automatically adjust according to the conditions of different users to truly meet the user's needs.

### SUMMARY

In view of the above, the present disclosure provides a method for adjusting a seat, which may indirectly obtain relevant information about the user's sitting posture or physique through sensors, as well as the adjustable range behind the seat, to automatically and appropriately adjust the seat forward or backward.

A first aspect of the present disclosure provides a method for adjusting a seat. The method includes obtaining, through a sensor system, a first distance starting from a front surface of a seat pan of the seat to a first point sensible by the sensor system and a second distance starting from a rear surface of a seat back of the seat to a second point sensible by the sensor system; and adjusting, through a seat adjustment mechanism, the seat forward or backward based on the first distance and the second distance.

In some implementations of the first aspect, adjusting, through the seat adjustment mechanism, the seat forward or backward based on the first distance and the second distance includes: adjusting the seat forward or backward through the seat adjustment mechanism based on the first distance, the second distance, a preset calf diameter, and a distance before an adjustment of the seat starting from the front surface of the seat pan.

In some implementations of the first aspect, the method further includes: determining, through a pressure sensor, a seating status of the seat; in a case that the seating status is determined to be unoccupied, obtaining the distance before the adjustment through the sensor system; and in a case that the seating status is determined to be occupied, obtaining the first distance through the sensor system.

In some implementations of the first aspect, adjusting, through the seat adjustment mechanism, the seat forward or backward based on the first distance, the second distance, the preset calf diameter, and the distance before the adjustment includes: determining a seat adjustment direction based on the first distance, the preset calf diameter, and the distance before the adjustment; and determining whether to stop adjusting the seat based on the second distance.

In some implementations of the first aspect, the sensor system comprises a first distance sensor positioned at the front surface of the seat pan and a second distance sensor positioned at the rear surface of the seat back.

In some implementations of the first aspect, a frequency band of the first distance sensor and the second distance sensor is in a megahertz range.

A second aspect of the present disclosure provides a seat adjustment system. The seat adjustment system includes a sensor system and a controller coupled to the sensor system. The controller is further coupled to a seat adjustment mechanism of a seat. The sensor system is configured to obtain a first distance starting from a front surface of a seat pan of the seat to a first point sensible by the sensor system and a second distance starting from a rear surface of a seat back of the seat to a second point sensible by the sensor system. The controller is configured to adjust, through the seat adjustment mechanism, the seat forward or backward based on the first distance and the second distance.

In some implementations of the second aspect, the seat adjustment system further includes a memory coupled to the controller and configured to store a preset calf diameter and a distance before an adjustment of the seat starting from the front surface of the seat pan of the seat. The controller further is configured to adjust, through the seat adjustment mechanism, the seat forward or backward based on the first distance, the second distance, the preset calf diameter, and the distance before the adjustment.

In some implementations of the second aspect, the controller is further coupled to a pressure sensor of the seat and is configured to: determine a seating status of the seat through the pressure sensor; in a case that the seating status is determined to be unoccupied, obtain the distance before the adjustment through the sensor system; and in a case that the seating status is determined to be occupied, obtain the first distance through the sensor system.

In some implementations of the second aspect, adjusting the seat forward or backward based on the first distance, the second distance, the preset calf diameter, and the distance before the adjustment includes: determining a seat adjustment direction based on the first distance, the preset calf diameter, and the distance before the adjustment; and determining whether to stop adjusting the seat based on the second distance.

In some implementations of the second aspect, the sensor system includes a first distance sensor positioned at the front surface of the seat pan, and a second distance sensor positioned at the rear surface of the seat back.

In some implementations of the second aspect, a frequency band of the first distance sensor and the second distance sensor is in a megahertz range.

A third aspect of the present disclosure provides a controller for adjusting a seat. The controller is coupled to a sensor system and a seat adjustment mechanism, and is configured to: obtain, from the sensor system, a first distance starting from a front surface of a seat pan of the seat to a first point sensible by the sensor system and a second distance starting from a rear surface of a seat back of the seat to a second point sensible by the sensor system; and adjust, through the seat adjustment mechanism, the seat forward or backward based on the first distance and the second distance.

In some implementations of the third aspect, adjusting, through the seat adjustment mechanism, the seat forward or backward based on the first distance and the second distance includes: adjusting, through the seat adjustment mechanism, the seat forward or backward based on the first distance, the second distance, a preset calf diameter, and a distance before an adjustment of the seat starting from the front surface of the seat pan.

In some implementations of the third aspect, the controller is further coupled to a pressure sensor of the seat and is further configured to: determine, through the pressure sensor, a seating status of the seat; in a case that the seating status is determined to be unoccupied, obtain the distance before the adjustment through the sensor system; and in a case that the seating status is determined to be occupied, obtain the first distance through the sensor system.

In some implementations of the third aspect, adjusting, through the seat adjustment mechanism, the seat forward or backward based on the first distance, the second distance, the preset calf diameter, and the distance before the adjustment includes: determining a seat adjustment direction based on the first distance, the preset calf diameter, and the distance before the adjustment; and determining whether to stop adjusting the seat based on the second distance.

In some implementations of the third aspect, the sensor system includes a first distance sensor positioned at the front surface of the seat pan and a second distance sensor positioned at the rear surface of the seat back.

In some implementations of the third aspect, a frequency band of the first distance sensor and the second distance sensor is in a megahertz range.

Based on the above, the method, system, and controller for seat adjustment provided in the implementations the present disclosure obtain distance information of specific positions and directions of the seat through a sensor system, indirectly acquiring relevant information about the user's sitting posture or physique, as well as the adjustable range behind the seat. Accordingly, the seat may be automatically and appropriately adjusted forward or backward.

### BRIEF DESCRIPTION OF THE DRAWINGS

FIG. 1 illustrates a block diagram of a seat adjustment system in accordance with an example implementation of the present disclosure.

FIG. 2 illustrates a flowchart of a method for adjusting a seat in accordance with an example implementation of the present disclosure.

FIG. 3 illustrates a schematic diagram of a method for adjusting a seat in accordance with an example implementation of the present disclosure.

FIG. 4 illustrates a flowchart of a method for adjusting a seat in accordance with an example implementation of the present disclosure.

### DETAILED DESCRIPTION

The following description contains specific information related to exemplary implementations of the present disclosure. The drawings and their accompanying detailed descriptions in the present disclosure are merely exemplary implementations. However, the present disclosure is not limited to these exemplary implementations. Those skilled in the art will appreciate various modifications and alternative implementations of the present disclosure are possible. Unless otherwise indicated, identical or corresponding elements in the drawings may be indicated by the same or corresponding reference numerals. In addition, the drawings and examples in the present disclosure are generally not drawn to scale and do not correspond to actual relative sizes.

For the sake of consistency and clarity, similar features are labeled with the same reference numerals in the exemplary drawings (although this may not be the case in some examples). However, features in different implementations may differ in other respects, and should not be narrowly interpreted based solely on the features shown in the drawings.

The terms “at least one implementation,” “an implementation,” “multiple implementations,” “different implementations,” “some implementations,” and “the present implementation,” as used herein, may include specific features, structures, or characteristics, but not every possible implementation necessarily includes the particular features, structures, or characteristics. Additionally, the repeated use of phrases such as “in one implementation,” “in the present implementation,” does not necessarily refer to the same implementation, although they may be the same. Furthermore, phrases such as “implementations of the disclosure” associated with the term “the present disclosure” does not mean that all implementations of the disclosure necessarily include particular features, structures, or characteristics and should be understood to mean that “at least some implementations of the disclosure” include the specific features, structures, or characteristics described. The term “coupled” is defined as connected, whether directly or indirectly through intermediate components, and is not necessarily limited to physical connections. When the term “comprising” is used, it means “including but not limited to,” explicitly indicating an open-ended inclusion or relationship of combinations, groups, series, and the like.

Furthermore, specific details such as functional entities, technologies, protocols, standards, etc. have been explained for the purpose of explanation and non-limitation to provide an understanding of the described technology. In other examples, detailed descriptions of well-known methods, technologies, systems, architectures, etc. are omitted to avoid confusing the explanatory description with unnecessary details.

The terms “first,” “second,” and “third,” etc. used in the specification and the accompanying drawings of the present disclosure are intended to distinguish between different objects, rather than to describe a particular order. In addition, the term “comprising” and any variations thereof are intended to cover non-exclusive inclusion. For example, a process, method, system, product, or apparatus that includes a series of steps or modules is not limited to the listed steps or modules but may optionally include additional steps or modules not listed, or optionally include additional steps or modules inherent in such processes, methods, products, or apparatus.

The following description is provided in conjunction with the accompanying drawings to illustrate implementations of the present disclosure.

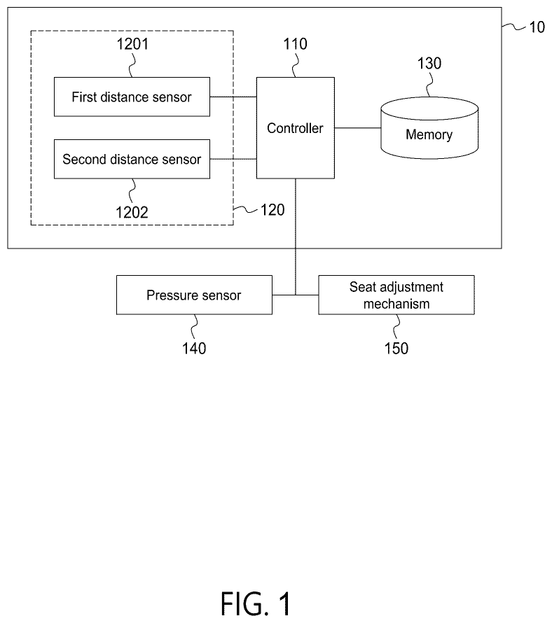

FIG. 1 illustrates a block diagram of a seat adjustment system in accordance with an example implementation of the present disclosure.

Referring to FIG. 1, a seat adjustment system 10 may be a system configured to perform adjustment of a seat, where the adjustment includes at least forward and backward positioning of the seat. Seat(s) applicable for the seat adjustment system 10 may be, for example, a car seat, a bus seat, an airplane seat, a cinema seat, etc., but the disclosure is not limited to these examples.

For instance, the seat may be installed on a rail, allowing it to move forward and backward on the rail through a seat adjustment mechanism (e.g., a motor). The seat adjustment system 10 may control the seat adjustment mechanism to adjust the seat forward or backward to the most suitable position for a user when the user is seated on the seat.

Generally, when a user is seated on a seat, due to differences in physique or sitting posture, the distance from the front surface of the seat pad of the seat to the user's calf may vary. Therefore, the seat may need to move appropriately forward or backward to accommodate the user's physique or sitting posture. On the other hand, when there are obstacle(s) behind the seat (e.g., an empty seat or another passenger), the distance from the rear surface of the seat back of the seat to the obstacle may limit how far the seat may move backward.

Referring to FIG. 1, the seat adjustment system 10 may include a controller 110 and a sensor system 120, where the sensor system 120 is coupled to the controller 110. The sensor system 120, for example, may be a distance measuring system, configured to obtain a first distance starting from the front surface of the seat pad of the seat to a point sensible by the sensor system 120 and a second distance starting from the rear surface of the seat back of the seat to another point sensible by the sensor system 120. The controller 110 may adjust the seat forward or backward based on the first and second distances through the seat adjustment mechanism.

In some implementations, the sensor system 120 may include a first distance sensor 1201 and a second distance sensor 1202. The first distance sensor 1201 may be positioned at the front surface of the seat pad of the seat and facing forward to obtain the first distance; the second distance sensor 1202 may be positioned at the rear surface of the seat back of the seat and facing backward to obtain the second distance. Specifically, when a user is seated, the first distance may be a distance starting from the front surface of the seat pad of the seat to the user's calf, and when the seat is empty, the first distance may be the maximum distance from the front surface of the seat pad of the seat to the space in front. On the other hand, the second distance may be a distance starting from the rear surface of the seat back of the seat to the obstacle behind.

In some implementations, a frequency band adopted by the first distance sensor 1201 is in the megahertz band. Waves in the megahertz band may penetrate clothing but not human skin. Therefore, using a first distance sensor 1201 of the megahertz band in the scenarios of the implementations of the present disclosure will not be affected by the user's clothing (e.g., baggy pants, skirts, etc.), ensuring more accurate distance measurements for seat adjustment. In some implementations, a frequency band adopted by the second distance sensor 1202 may also be in the megahertz band.

In some implementations, the controller 110 may be configured to control the overall operation of the seat adjustment system 10. The controller 110 may include a Central Processing Unit (CPU), or other programmable general-purpose or special-purpose microprocessors, Digital Signal Processors (DSP), programmable controllers, Application Specific Integrated Circuits (ASIC), Programmable Logic Devices (PLD), or combinations of these components, but are not limited to the examples provided herein.

In some implementations, the seat adjustment system 10 may also include a memory 130, which may include any form of fixed or removable Random Access Memory (RAM), Read-Only Memory (ROM), flash memory, hard drive, or other similar components or combinations of these components. The memory 130 may be coupled to the controller 110 and is configured to store various parameters and codes required for the seat adjustment method.

In some implementations, the memory 130 may record parameters, such as the calf diameter and a default optimal distance (will be described below), that are used during forward or backward seat adjustments. These parameters may be, for example but not limited to, set by the user or preset by the manufacturer.

In some implementations, the memory 130 may also record parameters such as the optimal clearance distance and the minimum tolerance distance (will be described below). These parameters may be, for example but not limited to, set by the user or preset by the manufacturer.

In some implementations, the controller 110 may also be coupled to a pressure sensor 140 of the seat and a seat adjustment mechanism 150 of the seat. The pressure sensor 140 may be, for instance, placed within the seat pad to detect the pressure applied on the pressure sensor, to help determine the seating status of the seat. The seat adjustment mechanism 150 may be configured to adjust the seat, including at least forward and backward adjustments. Additionally, both the pressure sensor 140 and the seat adjustment mechanism 150 may or may not be part of the seat adjustment system 10.

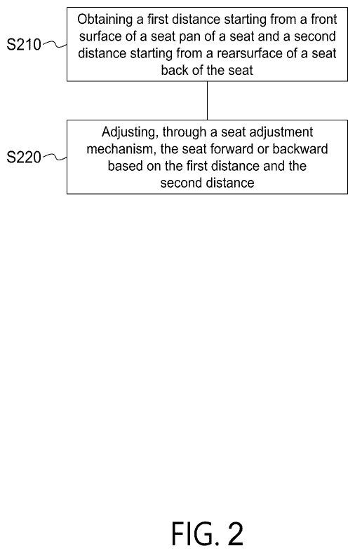

FIG. 2 illustrates a flowchart of a method for adjusting a seat in accordance with an example implementation of the present disclosure.

The method for adjusting a seat in the implementations of FIG. 2 is applicable to the seat adjustment system 10 of the implementations of FIG. 1, and thus will be described in conjunction with FIG. 1. However, it should be noted that the present disclosure is not limited to specific equipment for performing the method. In other words, those skilled in the art may also use equipment other than the seat adjustment system 10 to implement the method provided in the disclosure.

Referring to FIG. 2, in step S210, the controller 110 may obtain, through the sensor system 120, a first distance starting from the front surface of the seat pad of the seat (e.g., to a point sensible by the sensor system 120) and a second distance starting from the rear surface of the seat back of the seat (e.g., to another point sensible by the sensor system 120). In step S220, based on the first and second distances, the controller 110 may adjust the seat forward or backward using the seat adjustment mechanism 150.

A more detailed description of the method for adjusting the seat will be provided below, accompanied by a schematic diagram within the framework of the implementations of FIG. 2.

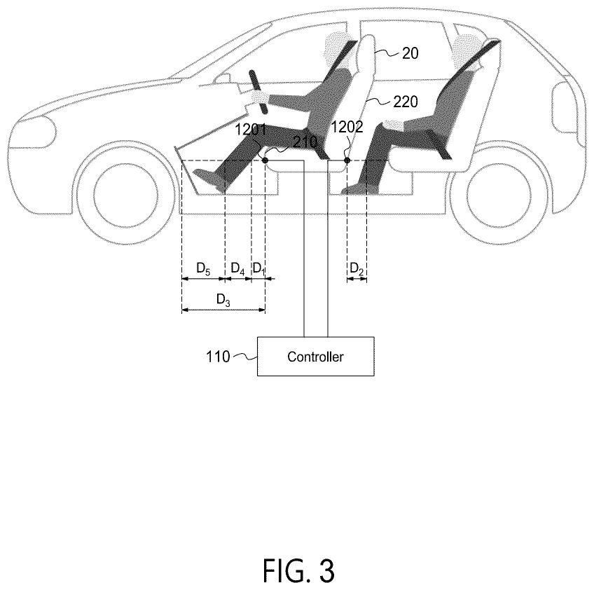

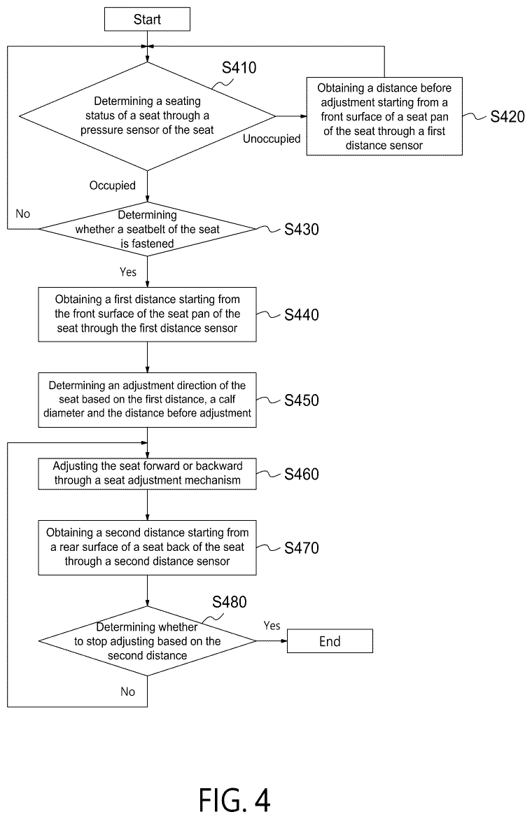

FIG. 3 illustrates a schematic diagram of a method for adjusting a seat in accordance with an example implementation of the present disclosure. FIG. 4 illustrates a flowchart of a method for adjusting a seat in accordance with an example implementation of the present disclosure.

The method in the implementations of FIG. 3 and FIG. 4 is applicable to the seat adjustment system 10 of the FIG. 1 implementation, and thus will be described in conjunction with FIG. 1. However, it should be noted that the present disclosure is not limited to specific equipment for performing the method. In other words, those skilled in the art may also use equipment other than the seat adjustment system 10 to implement the method provided in the disclosure.

Referring to FIG. 3, the sensor system 120 may include a first distance sensor 1201 and a second distance sensor 1202. The first distance sensor 1201 may be positioned at the front surface 210 of the seat pad of the seat 20, and the second distance sensor 1202 is positioned at the rear surface 220 of the seat back of the seat 20.

Referring to FIG. 3 and FIG. 4, in step S410, the controller 110 may determine the seating status of the seat 20 through the pressure sensor 140 on the seat. In a case that the seat status is determined to be unoccupied, step S420 is performed; in a case that the seat status is determined to be occupied, step S430 is performed.

Specifically, the controller 110 may determine the current seating status of the seat based on the readings from the pressure sensor 140, e.g., whether the seat is occupied or unoccupied. For instance, when the reading of the pressure sensor 140 reaches a preset threshold, the seat status may be determined to be “occupied”; otherwise, the seat status may be determined to be “unoccupied”.

In step S420, the controller 110 may obtain, through the first distance sensor 1210, a distance before adjustment D3 starting from the front surface 210 of the seat pad of the seat 20, and then returns to step S410. Specifically, the distance before adjustment D3 may be a distance measured from the front surface 210 of the seat pad of the seat 20 before the next user occupies the seat. In other words, the distance before adjustment D3 may represent the available space in front of the seat 20 before the next user occupies it.

In some implementations, the controller 110 may record the distance before adjustment D3 (e.g., through memory 130).

In some implementations, in a case that the seat 20 has not been adjusted since the last time the distance before adjustment D3 was obtained, step S420 may be skipped, and step S430 may be performed.

In step S430, the controller 110 may determine whether the seatbelt of the seat 20 is fastened. In a case that the seatbelt of the seat 20 is fastened, step S440 is performed; otherwise, step S410 is performed.

It should be noted that step S430 is optional. In some implementations, if the controller 110 determines in step S410 that the seat is occupied, step S440 may be performed directly.

In step S440, the controller 110 may obtain, through the first distance sensor 1210, a first distance D1 starting from the front surface 210 of the seat pad of the seat 20.

Specifically, when a user occupies, or is seated on, the seat 20, a calf of the user may obstruct the first distance sensor 1210. Thus, the first distance D1 may be a distance from the front surface 210 of the seat pad of the seat 20 to the user's calf.

In step S450, the controller 110 may determine an adjustment direction of the seat 20 based on the first distance D1, a calf diameter D4, and the distance before adjustment D3. The calf diameter D4 may be, for example but not limited to, set by the user or preset by the manufacturer.

Specifically, since the distance before adjustment D3 may represent the available space in front of the seat 20, subtracting the first distance D1 and the calf diameter D4 from the distance before adjustment D3 may give a clearance distance D5 in front of the user's calf. Generally, when the clearance distance D5 is sufficiently long, the user might feel spacious and comfortable. However, in some circumstances, there are constraints on the clearance distance D5. For instance, when the seat 20 is a driver's seat, a clearance distance D5 that may be excessive might prevent the user from reaching the accelerator or brake pedals.

In some implementations, the controller 110 may set an optimal clearance distance and compare the clearance distance D5 with the optimal clearance distance to determine the adjustment direction of the seat 20. For example, when the clearance distance D5 is greater than the optimal clearance distance, the controller 110 may determine to adjust the seat 20 forward, when the clearance distance D5 is less than the optimal clearance distance, the controller 110 may determine to adjust the seat 20 backward, and when the clearance distance D5 equals the optimal clearance distance, the controller 110 may determine not to adjust the seat 20.

In step S460, the controller 110 may adjust the seat 20 forward or backward through the seat adjustment mechanism 150. Specifically, the controller 110 may adjust the seat 20 forward or backward based on the adjustment direction determined in step S450.

In step S470, the controller 110 may obtain, through the second distance sensor 1220, a second distance D2 starting from the rear surface 220 of the seat back of the seat 20.

Specifically, there might be obstacle(s) behind the seat 20, such as a wall, rear seat(s), or passenger(s) (e.g., passengers'calves) seated in the rear seats. Thus, the second distance D2 may be the distance from the rear surface 220 of the seat back of the seat 20 to the obstacle(s).

In step S480, the controller 110 may determine whether to stop adjusting the seat 20 based on the second distance D2. In a case that the controller 110 determines that the adjustment should stop, the process ends, otherwise, step S460 is performed to continue adjusting the seat 20.

In some implementations, the controller 110 may set a minimum tolerance distance and compares the second distance D2 with the minimum tolerance distance to determine whether to stop adjusting the seat 20. For instance, when the second distance D2 is greater than the minimum tolerance distance, the controller 110 may determine not to stop adjusting the seat 20, and when the second distance D2 is less than or equal to the minimum tolerance distance, the controller 110 may determine to stop adjusting the seat 20. The minimum tolerance distance may be, for example but not limited to, set by the user or preset by the manufacturer for the controller 110.

In summary, the method, system, and controller for seat adjustment provided in the implementations of the present disclosure obtain distance information from specific positions and directions of the seat through the sensor system. This indirectly provides relevant information about the user's posture or physique, as well as the adjustable range behind the seat. Accordingly, the seat may be adjusted automatically and appropriately. Moreover, in some implementations, the sensor system uses waves within the megahertz frequency band, which may accurately obtain the distance to the user's body regardless of clothing, making it more suitable for seat adjustment scenarios.

Based on the above description, it is apparent that various techniques may be configured to implement the concepts described in this application without departing from their scope. Furthermore, although certain implementations have been specifically described and illustrated, those skilled in the art will recognize that variations and modifications may be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions may be made within the scope of the present disclosure.

What is claimed is:

1. A method for adjusting a seat, comprising:
obtaining, through a sensor system, a first distance starting from a front surface of a seat pan of the seat to a first point sensible by the sensor system and a second distance starting from a rear surface of a seat back of the seat to a second point sensible by the sensor system; and
adjusting, through a seat adjustment mechanism, the seat forward or backward based on the first distance and the second distance.

2. The method of claim 1, wherein adjusting, through the seat adjustment mechanism, the seat forward or backward based on the first distance and the second distance comprises:
adjusting, through the seat adjustment mechanism, the seat forward or backward based on the first distance, the second distance, a preset calf diameter, and a distance before an adjustment of the seat starting from the front surface of the seat pan.

3. The method of claim 2, further comprising:
determining, through a pressure sensor, a seating status of the seat;
in a case that the seating status is determined to be unoccupied, obtaining the distance before the adjustment through the sensor system; and
in a case that the seating status is determined to be occupied, obtaining the first distance through the sensor system.

4. The method of claim 2, wherein adjusting, through the seat adjustment mechanism, the seat forward or backward based on the first distance, the second distance, the preset calf diameter, and the distance before the adjustment comprises:
determining a seat adjustment direction based on the first distance, the preset calf diameter, and the distance before the adjustment; and
determining whether to stop adjusting the seat based on the second distance.

5. The method of claim 1, wherein the sensor system comprises a first distance sensor positioned at the front surface of the seat pan and a second distance sensor positioned at the rear surface of the seat back.

6. The method of claim 5, wherein a frequency band of the first distance sensor and the second distance sensor is in a megahertz range.

7. A seat adjustment system, comprising:
a sensor system, configured to obtain a first distance starting from a front surface of a seat pan of a seat to a first point sensible by the sensor system and a second distance starting from a rear surface of a seat back of the seat to a second point sensible by the sensor system; and
a controller, coupled to the sensor system and a seat adjustment mechanism, and configured to adjust, through the seat adjustment mechanism, the seat forward or backward based on the first distance and the second distance.

8. The seat adjustment system of claim 7, further comprising:
a memory, coupled to the controller, and configured to store a preset calf diameter and a distance before an adjustment of the seat starting from the front surface of the seat pan of the seat,
wherein the controller is further configured to adjust, through the seat adjustment mechanism, the seat forward or backward based on the first distance, the second distance, the preset calf diameter, and the distance before the adjustment.

9. The seat adjustment system of claim 8, wherein the controller is further coupled to a pressure sensor of the seat and is configured to:
determine a seating status of the seat through the pressure sensor;
in a case that the seating status is determined to be unoccupied, obtain the distance before the adjustment through the sensor system; and
in a case that the seating status is determined to be occupied, obtain the first distance through the sensor system.

10. The seat adjustment system of claim 8, wherein adjusting the seat forward or backward based on the first distance, the second distance, the preset calf diameter, and the distance before the adjustment comprises:
determining a seat adjustment direction based on the first distance, the preset calf diameter, and the distance before the adjustment; and
determining whether to stop adjusting the seat based on the second distance.

11. The seat adjustment system of claim 7, wherein the sensor system comprises:
a first distance sensor positioned at the front surface of the seat pan; and
a second distance sensor positioned at the rear surface of the seat back.

12. The seat adjustment system of claim 11, wherein a frequency band of the first distance sensor and the second distance sensor is in a megahertz range.

13. A controller for adjusting a seat, wherein the controller is coupled to a sensor system and a seat adjustment mechanism, and is configured to:
obtain, from the sensor system, a first distance starting from a front surface of a seat pan of the seat to a first point sensible by the sensor system and a second distance starting from a rear surface of a seat back of the seat to a second point sensible by the sensor system; and
adjust, through the seat adjustment mechanism, the seat forward or backward based on the first distance and the second distance.

14. The controller of claim 13, wherein adjusting, through the seat adjustment mechanism, the seat forward or backward based on the first distance and the second distance comprises:
adjusting, through the seat adjustment mechanism, the seat forward or backward based on the first distance, the second distance, a preset calf diameter, and a distance before an adjustment of the seat starting from the front surface of the seat pan.

15. The controller of claim 14, wherein the controller is further coupled to a pressure sensor of the seat and is further configured to:
determine, through the pressure sensor, a seating status of the seat;
in a case that the seating status is determined to be unoccupied, obtain the distance before the adjustment through the sensor system; and
in a case that the seating status is determined to be occupied, obtain the first distance through the sensor system.

16. The controller of claim 14, wherein adjusting, through the seat adjustment mechanism, the seat forward or backward based on the first distance, the second distance, the preset calf diameter, and the distance before the adjustment comprises:
determining a seat adjustment direction based on the first distance, the preset calf diameter, and the distance before the adjustment; and
determining whether to stop adjusting the seat based on the second distance.

17. The controller of claim 13, wherein the sensor system comprises a first distance sensor positioned at the front surface of the seat pan and a second distance sensor positioned at the rear surface of the seat back.

18. The controller of claim 17, wherein a frequency band of the first distance sensor and the second distance sensor is in a megahertz range.
